(19) United States
(12) Patent Application Publication
(10) Pub. No.: US 2017/0123159 A1
(43) Pub. Date: May 4, 2017

(54) ALIGNMENT SYSTEM FOR OPTICAL COUPLING ASSEMBLY

(71) Applicants: Dritan Celo, Nepean (CA); Eric Bernier, Kanata (CA)

(72) Inventors: Dritan Celo, Nepean (CA); Eric Bernier, Kanata (CA)

(21) Appl. No.: 14/925,153

(22) Filed: Oct. 28, 2015

(51) Int. Cl. G02B 6/30; G01B 7/31; G02B 6/36; G02B 6/34; G02B 6/293

(52) U.S. Cl. CPC G02B 6/30; G02B 6/34; G02B 6/29331; G02B 6/3656; G01B 7/31

(57) ABSTRACT

An alignment system for aligning a field space concentrator (FSC) joined to a fiber array unit (FAU) with a photonic integrated circuit (PIC) chip includes a first sensor on the PIC chip that responds electrically to interaction with a first alignment element on the FSC, a second sensor on the PIC chip that responds electrically to interaction with a second alignment element on the FSC, and a processor electrically connected to the first and second sensors for receiving and processing signals from the first and second sensors to determine an alignment of the FSC with the PIC chip.

### TECHNICAL FIELD

The present disclosure generally relates to optical couplings and, more particularly, to alignment of components in an optical coupling assembly.

### BACKGROUND

It is desirable to optically couple an array of fibers to a silicon photonic (SiPh) die. However, the mode field diameter (MFD) of a single mode fiber (SMF) output is much larger than the MFD of a nanophotonic wire on a silicon photonic chip. Optical coupling devices such as a field space concentrator (FSC) are often used to optically interface an SMF and a SiPh die. Such an interface can be accomplished with either evanescent or surface grating couplings. Both coupling are suitable for low-volume packaging, and are thus unsuitable for low-cost, high-volume packaging. Passive self-alignment systems and methods are therefore desirable for high-speed, low-cost optical interfacing of an FSC to the silicon photonic chip. One proposed technology uses a polymer ribbon for interfacing between the SMF array and the nanophotonic waveguides to reduce optical loss and to provide an easy-to-assemble optical coupling. This technology offers passive self-alignment suitable for automation using standard microelectronic packaging tools. This proposed technology employs a flexible FSC that reduces the effects of thermally induced cycling strains by mechanically decoupling the FSC from the SiPh chip. However, a significant drawback of this proposed technology is the lack of immediate alignment feedback. While the alignment process is completed by pick-and-place tooling, the alignment precision cannot be verified until light in the fiber is turned ON and an optical detection device is activated. Accordingly, it is highly desirable to devise a new alignment system and method that provide more immediate alignment feedback without requiring the detection of light.

### SUMMARY

The following presents a simplified summary of some aspects or embodiments of the invention in order to provide a basic understanding of the invention. This summary is not an extensive overview of the invention. It is not intended to identify key or critical elements of the invention or to delineate the scope of the invention. Its sole purpose is to present some embodiments of the invention in a simplified form as a prelude to the more detailed description that is presented later.

The present specification discloses an alignment system for aligning a field space concentrator (FSC) joined to a fiber array unit (FAU) with a photonic integrated circuit (PIC) chip. This alignment system includes two sensors capable of electrically sensing physical interactions with alignment elements on the FSC. The sensors respond electrically to the interactions, e.g. by generating signals that are processed by a processor to determine or ascertain an alignment of the FSC relative to the PIC chip. The novel alignment system and method provide inexpensive, optically passive alignment feedback for accept/reject decision-making in a production line or for lifetime monitoring of optical alignment by detecting any thermo-mechanically induced stresses that cause shifting on interface surfaces and misalignment. The alignment and monitoring feedback is electronic, without requiring any optical signal through the fiber array or photonic die. The processing circuitry can also be external to the photonic die, e.g. it can be connected with probe wires and or a flip-chip may be attached to it.

One inventive aspect of the disclosure is an alignment system for aligning a field space concentrator (FSC) joined to a fiber array unit (FAU) with a photonic integrated circuit (PIC) chip. The system includes a first sensor on the PIC chip that responds electrically to interaction with a first alignment element on the FSC, a second sensor on the PIC chip that responds electrically to interaction with a second alignment element on the FSC, and a processor electrically connected to the first and second sensors for receiving and processing signals from the first and second sensors to determine an alignment of the FSC with the PIC chip.

Another inventive aspect of the disclosure is a method of aligning a field space concentrator (FSC) joined to a fiber array unit (FAU) with a photonic integrated circuit (PIC) chip. The method entails sensing, using a first sensor on the PIC chip, interaction with a first alignment element on the FSC, sensing, using a second sensor on the PIC chip, interaction with a second alignment element on the FSC, and receiving and processing signals using a processor that is electrically connected to the first and second sensors to determine an alignment of the FSC with the PIC chip.

Another inventive aspect of the disclosure is an optical assembly including a fiber array unit (FAU) comprising an array of optical fibers, a field space concentrator (FSC) connected to the FAU, a photonic integrated circuit (PIC) chip connected to the FSC and an alignment system for monitoring alignment of the FSC with the (PIC) chip. The alignment system includes a first sensor on the PIC chip that responds electrically to interaction with a first alignment element on the FSC, a second sensor on the PIC chip that responds electrically to interaction with a second alignment element on the FSC, and a processor electrically connected to the first and second sensors for receiving and processing signals from the first and second sensors to determine an alignment of the FSC with the PIC chip.

### BRIEF DESCRIPTION OF THE DRAWINGS

These and other features of the disclosure will become more apparent from the description in which reference is made to the following appended drawings.

FIG. 1 is a top view of one embodiment of an alignment system for aligning a field space concentrator (FSC), which is joined to a fiber array unit (FAU), with a photonic integrated circuit (PIC) chip.

FIG. 2 is a front view of the alignment system.

FIG. 3 is a top view of another embodiment of an alignment system for aligning a field space concentrator (FSC), which is joined to a fiber array unit (FAU), with a photonic integrated circuit (PIC) chip.

FIG. 4 depicts a capacitive sensor not interacting with an alignment element of the FSC.

FIG. 5 depicts the capacitive sensor interacting with the alignment element of the FSC.

FIG. 6 depicts an alignment system having a capacitance-to-digital converter.

FIG. 7 depicts an alignment system having an RF MEMS switch not interacting with an alignment element of the FSC.

FIG. 8 depicts the RF MEMS switch interacting with the alignment element of the FSC.

FIG. 9 is a flowchart depicting an alignment method.

### DETAILED DESCRIPTION OF EMBODIMENTS

The following detailed description contains, for the purposes of explanation, numerous specific embodiments, implementations, examples and details in order to provide a thorough understanding of the invention. It is apparent, however, that the embodiments may be practiced without these specific details or with an equivalent arrangement. In other instances, some well-known structures and devices are shown in block diagram form in order to avoid unnecessarily obscuring the embodiments of the invention. The description should in no way be limited to the illustrative implementations, drawings, and techniques illustrated below, including the exemplary designs and implementations illustrated and described herein, but may be modified within the scope of the appended claims along with their full scope of equivalents.

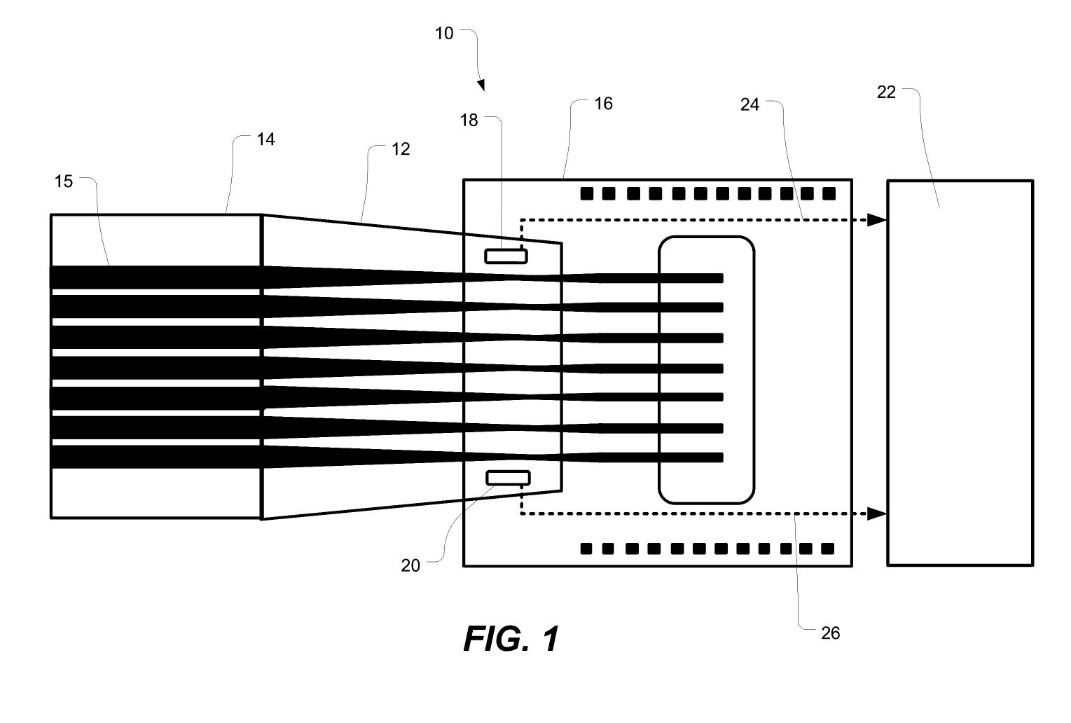

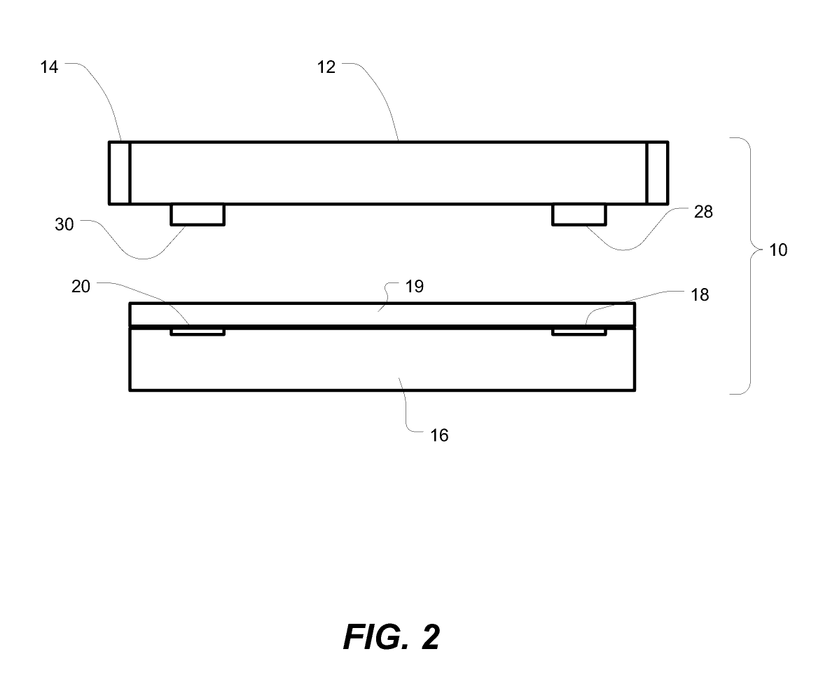

In the embodiment shown by way of example in FIG. 1, an alignment system generally designated by reference numeral 10 is provided for the purpose of aligning a field space concentrator (FSC) 12, which is joined to a fiber array unit (FAU) 14, with a photonic integrated circuit (PIC) chip 16. The FAU 14 has a plurality of optical fibers 15 as shown by way of example. The alignment system 10 includes a first sensor 18 on the PIC chip that responds electrically to interaction with a first alignment element 28 (shown in FIG. 2) on the FSC. The alignment system 10 includes a second sensor 20 on the PIC chip that responds electrically to interaction with a second alignment element 30 (shown in FIG. 2) on the FSC. For the purposes of this specification, it shall be understood that “interaction” means either physical contact or coming into close proximity such that the sensor reacts, responds or otherwise detects the presence of the alignment element. As shown by way of example in FIG. 1, the alignment system 10 includes a processor 22 (e.g. microprocessor, microcontroller, processing unit, etc.) electrically connected to the first and second sensors 18, 20 for receiving and processing signals from the first and second sensors 18, 20 to determine an alignment of the FSC with the PIC chip. Electrical connections 24, 26 are shown schematically in FIG. 1. The electrical connection are wires, conductive pathways or the like that conduct current from the sensors 18, 20 to the processor 22. The processor in FIG. 1 is shown off the PIC chip although in other embodiments, as will be explained in greater detail below, the processor may be on, or embedded in, the PIC chip.

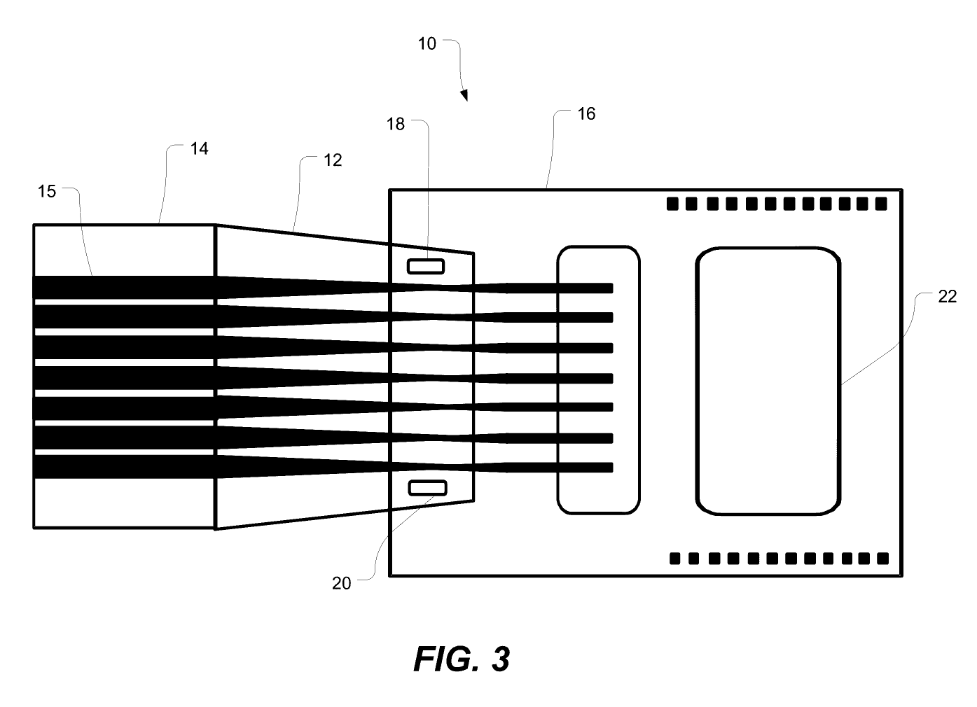

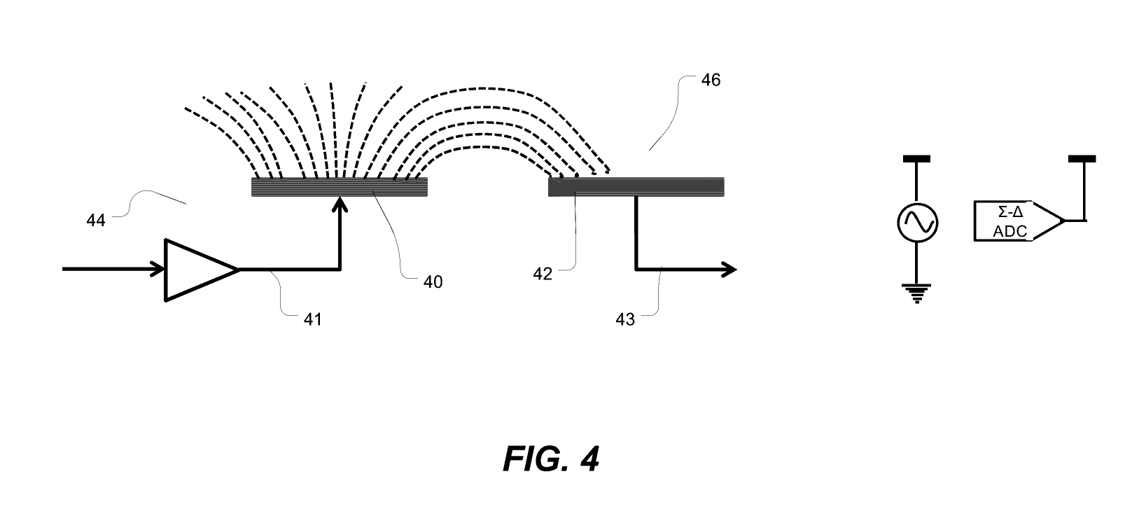

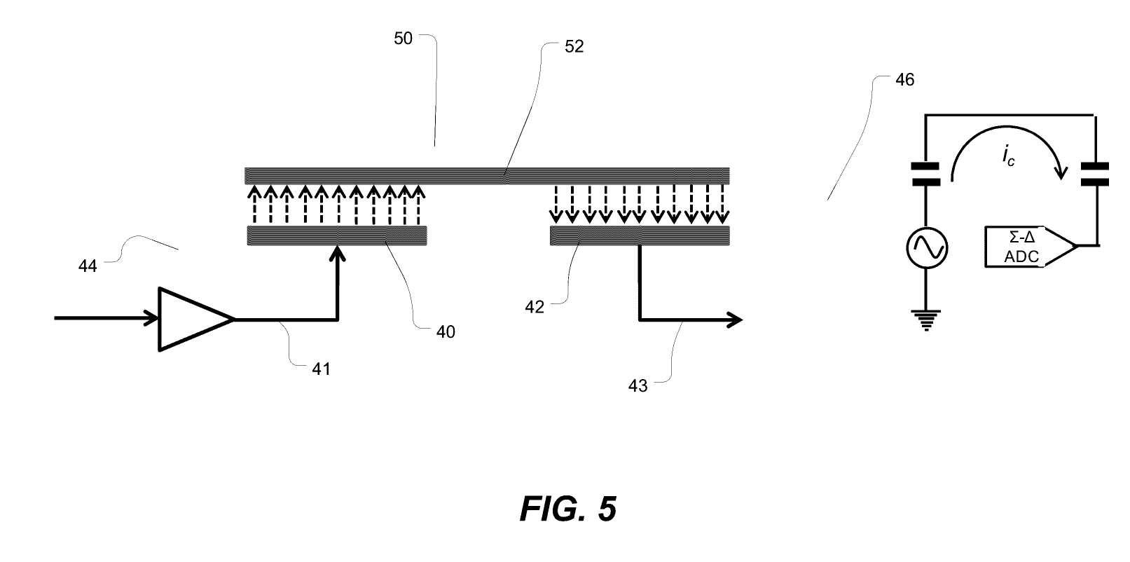

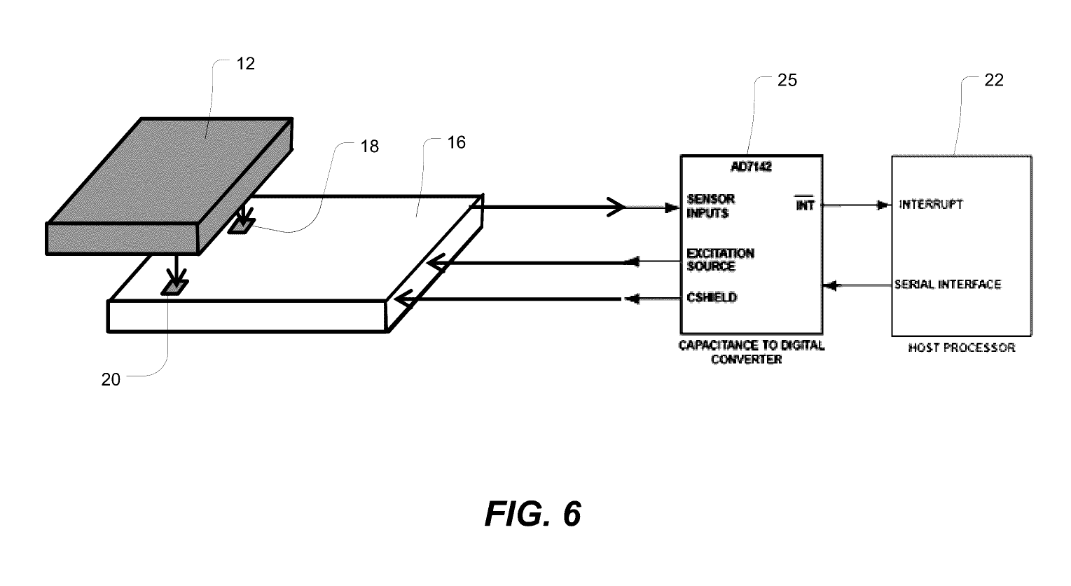

In the embodiment depicted in FIGS. 1 and 2, the first and second sensors 18, 20 are capacitive sensors that generate first and second electrical output signals when the FSC is aligned with the PIC chip. In the embodiment shown in FIG. 2, each alignment 28, 30 element is an electrically conductive plate (or equivalent structure) disposed on an underside of the FSC and each capacitive sensor 18, 20 comprises a pair of spaced-apart electrodes on the PIC chip (as shown in FIGS. 4 and 5). A dielectric layer 19 is disposed on the PIC chip covering the electrodes. The sensors are connected to a capacitance-to-digital converter as will be described in greater detail below with reference to FIG. 6. As shown by way of example in FIG. 1, the sensors 18, 20 are connected via probe wires 24, 26 to the processor 22 for in-production testing. Alternatively, in another embodiment, the sensors can be connected to a printed circuit board (PCB) on which the processor is mounted. In the embodiment shown in FIG. 3, the sensors 18, 20 are connected to a complementary metal-oxide-semiconductor (CMOS) flip-chip which acts as the processing unit or processor 22.

Capacitive sensing, which represents the best mode known to the inventors, is further described with reference to FIGS. 4 and 5. Details of the capacitive sensor are depicted in FIGS. 4 and 5. Each capacitor sensor includes a pair of spaced-apart electrodes 40, 42 on the PIC chip, namely a drive electrode 40 and a receive electrode 42. The electrodes 40, 42 are embedded within a dielectric base member (e.g. SiPh die). A dielectric layer 46 is disposed on the PIC chip covering the electrodes 40, 42. A drive buffer 41 charges the drive electrode. Collected charge 43 serves as the output signal. In FIG. 4, the FSC is absent (not aligned or interacting with the capacitive sensor). The electric field is weak so there is no output signal. In FIG. 5, the alignment element 52 attached to the underside of the FSC 50 is shown interacting with the capacitive sensor to produce an output signal signifying that the FSC is aligned with the PIC chip.

FIG. 6 depicts an alignment system having a capacitance-to-digital converter 25 that receives first and second output signals from the first and second capacitive sensors 18, 20 integrated into the PIC chip 16 when the FSC 12 is aligned with the PIC chip 16. For example, an Analog Devices AD7142 Programmable Controller (or any equivalent controller) may be used as a programmable capacitance-to-digital converter. With a 36 ms update rate and a better than 1 fF resolution, two series capacitors each 100×100 μm² can provide 0.87 fF/μm. The surface area of the capacitors can of course be increased or decreased to provide higher or lower capacitance values depending on the sensitivity of the controller.

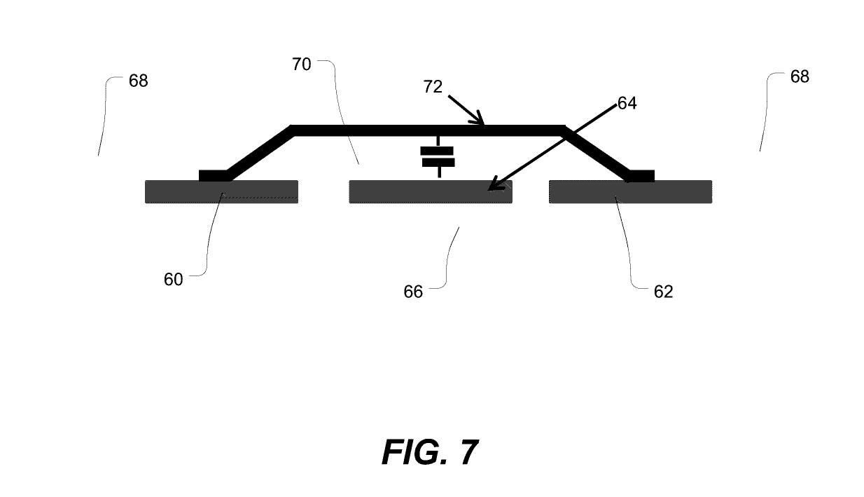

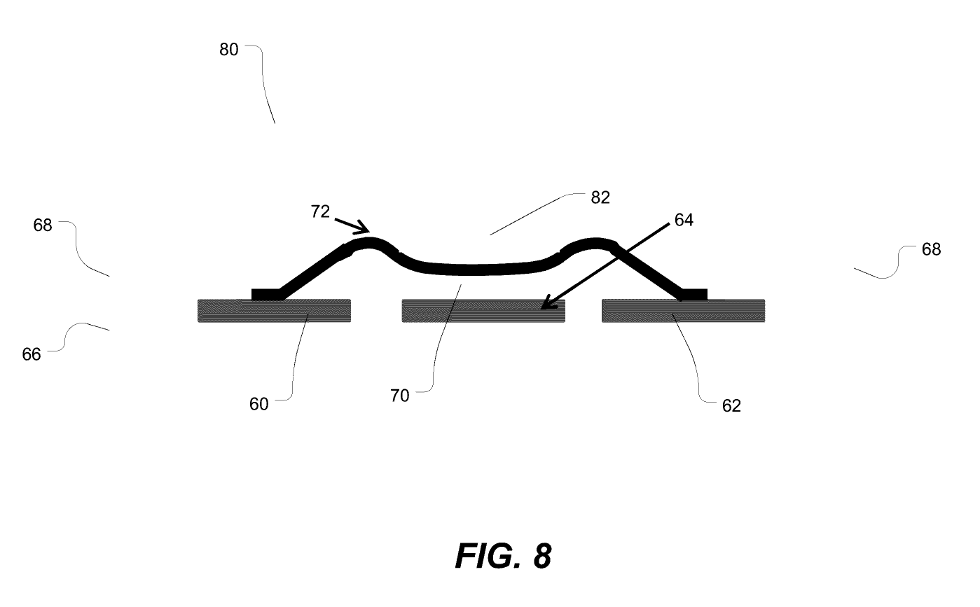

In the embodiment depicted in FIGS. 7 and 8, the first and second sensors 18, 20 are radio frequency (RF) microelectromechanical system (MEMS) switches that close when the FSC is aligned with the PIC chip. Each alignment element is a dielectric ridge 82 protruding from an underside of the FSC 80. Each of the RF MEMS switches comprises a pair of spaced-apart, electrically conductive plates 60, 62 integrated into the PIC chip as well as an actuation electrode 64 integrated into the dielectric base member 66 (e.g. a SiPh die with silicon dioxide layer) of the PIC chip between the plates 60, 62. The actuation electrode 64 is also spaced apart from the plates 60, 62. A dielectric layer 70 covers the actuation electrode. A bridge-like membrane (or “bridge”) 72 connects the plates 60, 62. The membrane 72 extends over the dielectric layer and the actuation electrode. In operation, an RF signal is blocked when the membrane 72 contacts the actuation electrode as shown in FIG. 8. The RF signal is able to pass when the membrane is spaced apart (disconnected) from the actuation electrode as shown in FIG. 7. Contact between the membrane 72 and the actuation electrode 70 occurs when the ridge 82 of the FSC 80 presses down against the membrane, which only happens if the alignment element and sensor co-located. When both sensors are co-located simultaneously with both alignment elements, the processor determines that this indicates that the FSC is aligned with the PIC chip. The RF MEMS switches may be replaced in other embodiments with other (non-RF) MEMS switches.

Alternatively, in another embodiment, the first and second sensors are ohmic sensors configured to generate first and second electrical output signals when the FSC is aligned with the PIC chip.

The alignment system disclosed herein may be used either for an evanescent coupling or a surface grating coupling.

The alignment system may be built into an optical assembly for lifetime monitoring of the alignment. The optical assembly thus includes the fiber array unit (FAU) 14 comprising an array of optical fibers 15, the field space concentrator (FSC) 12 connected to the FAU, the photonic integrated circuit (PIC) chip 16 connected to the FSC, and the alignment system 10 for monitoring alignment of the FSC with the (PIC) chip. As noted above, the alignment system 10 includes integrated sensing units (capacitive or resistive) fabricated into, i.e. embedded or integrated into, the SiPh die using CMOS-like microfabrication technology. As described above, the sensing units (sensors) can be sensing capacitors with metal electrodes integrated into the SiPh die and SiO₂ (silica) as the dielectric medium. Alternatively, capacitive (or ohmic) switches based on MEMS technology may be employed. Alternatively, RF MEMS switches may be employed. A programmable controller for sensing capacitance (or resistance) may be either a capacitance-to-digital converter (CDC), e.g. AD7142, or an analog-to-digital converter (ADC) or any suitable CMOS controller attached to the SiPh die using flip-chip technology. As noted above, electrical connections between the sensors and processor could be through probing (in production line) or through the SiPh die into the CMOS flip-chip or PCB carrier (for service life monitoring). To determine the alignment, a minimum of two sensors are integrated into the PIC chip.

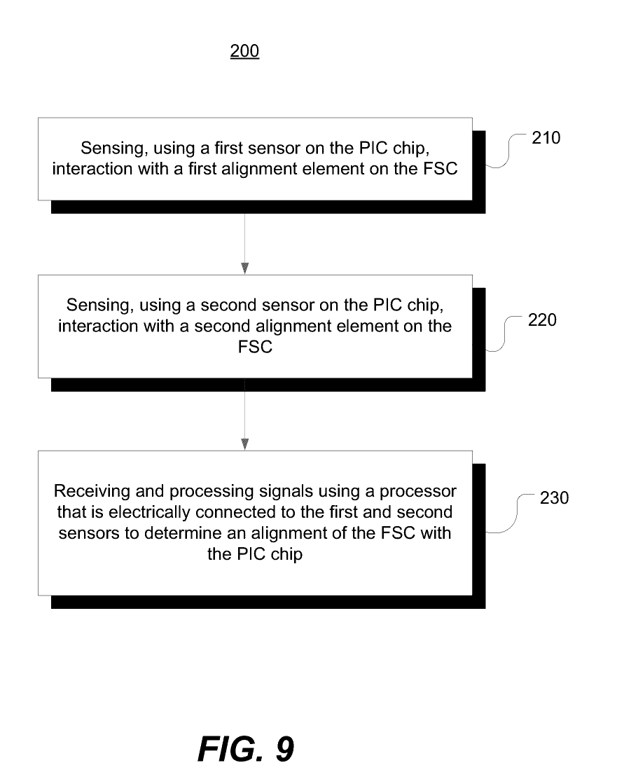

Another inventive aspect of the disclosure is a method of aligning a field space concentrator (FSC), which is joined to a fiber array unit (FAU), with a photonic integrated circuit (PIC) chip. As depicted in the flowchart of FIG. 9, the method 200 entails a step, act or operation 210 of sensing, using a first sensor on the PIC chip, interaction with a first alignment element on the FSC and a step, act or operation 220 of sensing, using a second sensor on the PIC chip, interaction with a second alignment element on the FSC. The sensing steps, acts or operations 210, 220 may be performed substantially simultaneously. The method 200 may entail a further step, act or operation 230 of receiving and processing signals using a processor that is electrically connected to the first and second sensors to determine an alignment of the FSC with the PIC chip.

In one implementation, sensing the interactions with the first and second alignment elements may entail using capacitive sensors that generate first and second electrical output signals when the FSC is aligned with the PIC chip. In another implementation, sensing the interactions with the first and second alignment elements comprises using radio frequency (RF) microelectromechanical system (MEMS) switches that close when the FSC is aligned with the PIC chip. In yet another implementation, sensing the interactions with the first and second alignment elements comprises using ohmic sensors configured to generate first and second electrical output signals when the FSC is aligned with the PIC chip.

The alignment system and method provide sensing technology for quality control in the optical alignment of an FSC with a SiPh die. This is useful both in production-line testing of placement accuracy and also for in-service monitoring. The output signal of the electronic sensing device indicates the FSC location. Two such readings indicate how precise the alignment is. The tolerance of the alignment can be set as criteria for an accept/reject decision. The sensing technology is electrical as opposed to optical. The electrical sensors are electrically connected through the SiPh die which serves as an interface between the sensors (or sensing units) and the processor (processing unit). The system may include a capacitance-to-digital or analog-to-digital converter. Alternatively, this converter may be integrated within the processor. The processor can be mounted on the same PCB as the photonics chip or it may be incorporated as a flip-chip into the photonics die.

The electronic sensing units can be fabricated into the SiPh die to interact with detectable electrodes on the FSC contact surface, e.g. underside of the FSC. Electronic sensing can be performed using (a) integrated capacitive or resistive sensors, where the signal path can be closed or interrupted through a series of capacitors or resistors, or (b) integrated RF MEMS switches which could be either ohmic or capacitive. However, it should be noted that capacitive sensing represents the best mode because ohmic depends on contact resistance which is difficult to measure reliably when the applied contact force varies. Sensing units may be fabricated using CMOS-like technology, i.e. the same technology used to fabricate the photonic die. Detectable electrodes on the contact surface of the FSC may be either electrically conductive (for capacitive or resistive sensing) or electrically nonconductive (for RF MEMS or MEMS switching).

This alignment system and method facilitate high-precision microelectronic assembly of optical fibers to photonic integrated circuits. This alignment system and method enable efficient and reliable testing of the alignment quality of a finished, packaged or assembled device by providing immediate electrical feedback permitting an accept/reject decision to be made. It can also be used to monitor optical alignment/positioning during the operation or service life of the device.

The alignment system and method are useful for optoelectronic packaging of photonic dies for a variety of applications, such as metro core networks, wireless aggregation networks or Cloud Radio Access Networks (C-RAN), data center transceivers, data center core switching networks, coherent optical transceivers in metro and long haul networks.

It is to be understood that the singular forms “a”, “an” and “the” include plural referents unless the context clearly dictates otherwise. Thus, for example, reference to “a device” includes reference to one or more of such devices, i.e. that there is at least one device. The terms “comprising”, “having”, “including”, “entailing” and “containing”, or verb tense variants thereof, are to be construed as open-ended terms (i.e., meaning “including, but not limited to,”) unless otherwise noted. All methods described herein can be performed in any suitable order unless otherwise indicated herein or otherwise clearly contradicted by context. The use of examples or exemplary language (e.g. “such as”) is intended merely to better illustrate or describe embodiments of the invention and is not intended to limit the scope of the invention unless otherwise claimed.

While several embodiments have been provided in the present disclosure, it should be understood that the disclosed systems and methods might be embodied in many other specific forms without departing from the scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the inventive concept(s) disclosed herein.

1. An alignment system for aligning a field space concentrator (FSC) joined to a fiber array unit (FAU) with a photonic integrated circuit (PIC) chip, the system comprising:
a first sensor on the PIC chip that responds electrically to interaction with a first alignment element on the FSC;
a second sensor on the PIC chip that responds electrically to interaction with a second alignment element on the FSC;
wherein the first and second sensors are capacitive sensors that generate first and second electrical output signals when the FSC is aligned with the PIC chip;
wherein each alignment element is an electrically conductive plate disposed on an underside of the FSC and wherein each capacitive sensor comprises a pair of spaced-apart electrodes on the PIC chip and a dielectric layer on the PIC chip covering the electrodes; and
a processor electrically connected to the first and second sensors for receiving and processing signals from the first and second sensors to determine an alignment of the FSC with the PIC chip.

2. (canceled)

3. The alignment system of claim 1 wherein the first and second sensors are radio frequency (RF) microelectromechanical system (MEMS) switches that close when the FSC is aligned with the PIC chip.

4. The alignment system of claim 1 wherein the first and second sensors are ohmic sensors configured to generate first and second electrical output signals when the FSC is aligned with the PIC chip.

5. (canceled)

6. The alignment system of claim 3 wherein each alignment element is a dielectric ridge protruding from an underside of the FSC and wherein each of the RF MEMS switches comprises:
a pair of spaced-apart, electrically conductive plates on the PIC chip;
an actuation electrode disposed on the PIC chip between the plates and spaced apart from the plates;
a dielectric layer covering the actuation electrode;
a bridge-like membrane connecting the plates, the membrane extending over the dielectric layer and the actuation electrode, wherein an RF signal is blocked when the membrane contacts the actuation electrode and wherein the RF signal is able to pass when the membrane is spaced apart from the actuation electrode.

7. The alignment system of claim 1 wherein the sensors are connected to a capacitance-to-digital converter.

8. The alignment system of claim 1 wherein the sensors are connected via probe wires to the processor for in-production testing.

9. The alignment system of claim 1 wherein the sensors are connected to a printed circuit board (PCB) on which the processor is mounted.

10. The alignment system of claim 1 wherein the sensors are connected to a CMOS flip-chip.

11. The alignment system of claim 1 wherein the FSC provides an evanescent coupling.

12. The alignment system of claim 1 wherein the FSC provides a surface grating coupling.

13. A method of aligning a field space concentrator (FSC) joined to a fiber array unit (FAU) with a photonic integrated circuit (PIC) chip, the method comprising:
sensing, using a first capacitive sensor on the PIC chip, interaction with a first alignment element on the FSC, the first capacitive sensor comprising a first pair of spaced-apart electrodes on the PIC chip and a first dielectric layer on the PIC chip covering the electrodes;
sensing, using a second capacitive sensor on the PIC chip, interaction with a second alignment element on the FSC, the second capacitive sensor comprising a second pair of spaced-apart electrodes on the PIC chip and a second dielectric layer on the PIC chip covering the electrodes,
wherein each alignment element is an electrically conductive plate disposed on an underside of the FSC;
generating first and second electrical output signals when the FSC is aligned with the PIC chip; and
receiving and processing the electrical output signals using a processor that is electrically connected to the first and second sensors to determine an alignment of the FSC with the PIC chip.

14. (canceled)

15. The method of claim 13 wherein sensing the interactions with the first and second alignment elements comprises using radio frequency (RF) microelectromechanical system (MEMS) switches that close when the FSC is aligned with the PIC chip.

16. The method of claim 13 wherein sensing the interactions with the first and second alignment elements comprises using ohmic sensors configured to generate first and second electrical output signals when the FSC is aligned with the PIC chip.

17. An optical assembly comprising:
a fiber array unit (FAU) comprising an array of optical fibers;
a field space concentrator (FSC) connected to the FAU;
a photonic integrated circuit (PIC) chip connected to the FSC; and
an alignment system for monitoring alignment of the FSC with the (PIC) chip, the system comprising:
a first sensor on the PIC chip that responds electrically to interaction with a first alignment element on the FSC;
a second sensor on the PIC chip that responds electrically to interaction with a second alignment element on the FSC;
wherein the first and second sensors are capacitive sensors that generate first and second electrical output signals when the FSC is aligned with the PIC chip;
wherein each alignment element is an electrically conductive plate disposed on an underside of the FSC and wherein each capacitive sensor comprises a pair of spaced-apart electrodes on the PIC chip and a dielectric layer on the PIC chip covering the electrodes; and
a processor electrically connected to the first and second sensors for receiving and processing signals from the first and second sensors to determine an alignment of the FSC with the PIC chip.

18. (canceled)

19. The assembly of claim 18 wherein the first and second sensors are radio frequency (RF) microelectromechanical system (MEMS) switches that close when the FSC is aligned with the PIC chip.

20. The assembly of claim 18 wherein the first and second sensors are ohmic sensors configured to generate first and second electrical output signals when the FSC is aligned with the PIC chip.
